(19) United States
(12) Patent Application Publication
(10) Pub. No.: US 2009/0004416 A1
(43) Pub. Date: Jan. 1, 2009

(54) Injection Molded Article

(75) Inventor: Morten Augestad, Porsgrunn (NO)

Correspondence Address: KNOBBE MARTENS OLSON & BEAR LLP, 2040 MAIN STREET, FOURTEENTH FLOOR, IRVINE, CA, 92614, US

(73) Assignee: Borealis Technology OY, Porvoo (FI)

(21) Appl. No.: 12/097,008

(22) PCT Filed: Dec. 11, 2006
(86) PCT No.: PCT/EP2006/011906

§ 371 Date: Jul. 11, 2008

(30) Foreign Application Priority Data
Dec. 12, 2005 (EP) 05257600.6

(51) Int. Cl. B65D 23/08; B29C 45/14

(52) U.S. Cl. 428/36.6; 264/267; 428/35.7

(57) ABSTRACT

An injection molded article formed from a polypropylene polymer and having an in mold label located inside the article is disclosed. The article may contain a product such as a product that contains an organic solvent.

This invention relates to injection moulded articles, in particular to injection moulded polypropylene articles, e.g. heterophasic block copolymer articles, suitable for packaging solvent based products or aqueous based products containing high levels of organic solvent as well as to processes for the manufacture thereof.

Many aqueous based products such as water-based household paint are typically packaged in polypropylene based containers. Such containers are relatively cheap and simple to make, are light and easy to transport and are strong and potentially recyclable.

Such containers are however, unsuitable for packaging solvent based products and products that cure in the presence of oxygen because polypropylene shows insufficient resistance to solvents and allows oxygen to migrate into the container from the external air. Such containers also fail to sufficiently prevent the egress of solvent, thus allowing the product to deteriorate during storage. Solvent based products such as certain inks, leather tanning products, agricultural pesticides, paints and all kinds of oils (e.g. fuels) etc are therefore conventionally packaged in metal or glass containers.

Metal containers are expensive and heavy and glass containers breakable so there remains a need to produce polypropylene containers, for packaging solvent based materials such as paints and for packaging materials which cure in the presence of oxygen, which are resistant to solvents and prevent oxygen migration. Such containers must additionally be strong and cheap to manufacture and transport.

The inventors have surprisingly found that a container formed from polypropylene can be used successfully in these applications if the container is provided with an internal in mould label. The combination of an internal in mould label and a polypropylene container has been found to possess the necessary solvent resistance and barrier properties (i.e. the prevention of oxygen migration). A polypropylene injection moulded article can be formed which may replace the metal or glass containers conventionally employed in the field. Such polypropylene containers have the additional advantage of being light in comparison to glass or metal containers and are therefore easier to transport and lighter for the end user to carry.

The use of in mould labels with polypropylene containers is not itself new. Such labels are used routinely on the outside of polypropylene containers for all manner of products as labels, i.e. for aesthetic reasons. The use of an in mould label internally is not however considered in labelling for obvious reasons—the label would not be visible.

The use therefore of an internal in mould label with polypropylene containers is not well known. In JP 10-129737, the possibility of using an in mould label on the inside of a food container is discussed to improve the oxygen gas barrier properties of the container. The container can comprise an LDPE or polypropylene copolymer component. However, the use of internal in mould labels in food applications has not been commercialised since there is often a small gap in the label in the corner of a container or where the base and sides of a container meet. This small gap allows oxygen to penetrate the container in that area causing degradation of the product near the gap. In food applications, such degradation of a small amount of product means the whole product is contaminated and has to be thrown away.

The present inventors have realised that this is not a problem with solvent based materials such as paint or with non-edible materials were minor degradation of a part of the product occurs. When, for example, a paint is mixed prior to application to a surface, any tiny amount of degradation of the product is irrelevant as it is diluted throughout the remainder of the undamaged product. Surprisingly, therefore, the use of in mould label technology in non-food applications is still of great benefit.

Moreover, the present inventors have realised that the use of an internal in mould label prevents the loss of organic solvents from within the container. As noted above, polypropylene containers have previously not been used to carry solvent containing materials in view of their permeability to the solvents. The use of an internal in mould label has been surprisingly found to significantly prevent solvent losses and achieves this much more successfully than an external in mould label.

Thus, viewed from one aspect the invention provides an injection moulded article formed from a polypropylene polymer and having an in mould label located inside said article, said article containing a product comprising an organic solvent.

Viewed from another aspect, the invention provides an injection moulded article formed from a polypropylene polymer having an in mould label located inside said article, said polymer having an MFR₂ of greater than 10 g/10 min.

Viewed from another aspect the invention provides use of an injection moulded article formed from a polypropylene polymer and having an in mould label located inside said article to contain a product comprising an organic solvent.

Viewed from another aspect the invention provides a process for the preparation of an injection moulded article, said process comprising:
(I) placing an in mould label on the male side of an injection mould;
(II) injecting a polypropylene polymer into said injection mould to form said article, said polymer preferably having an MFR₂ of greater than 10 g/10 min;
(III) removing said article from the mould; and optionally
(IV) adding a product containing an organic solvent to said article.

The polypropylene used to form the injection moulded article of the invention may be a homopolymer or copolymer but is preferably a copolymer. The copolymer may be a random copolymer or block copolymer. Preferably the copolymer is heterophasic. Most preferably the polypropylene is a heterophasic block copolymer.

Propylene polymers of use in this invention may comprise:

(A) from 70 to 98 parts by weight of a crystalline propylene homopolymer, or a crystalline random copolymer of propylene with ethylene and/or C4-C10 α-olefins, containing from 0.5 to 10% by weight of ethylene and/or α-olefins

and

(B) from 2 to 30 parts by weight of an elastomeric copolymer of propylene with ethylene or one or more C4-C10 α-olefins that is partially soluble in xylene.

The fraction soluble in xylene at 25° C. contains from 25 to 60% (preferably 30 to 50%) by weight of ethylene and has an intrinsic viscosity value ranging from 1,5 to 4.5 (preferably 1,8 to 3.5) dl/g.

The polypropylene polymer composition preferably has a Melt Flow Rate (MFR₂) value (measured at 230° C., with 2.16 kg load) of from 2.5 to 100 g/10 min, preferably 2,5 to 60 g/10 min, e.g. at least 4 g/10 min, preferably greater than 10 g/10 min, e.g. at least 11 g/10 min, especially at least 13 g/10 min. Polypropylenes having higher MFR₂ values are of benefit because they give better flow yielding shorter cycle times and higher output.

Polypropylene copolymers may comprise comonomer(s) selected from ethylene or a C4-20-alpha-olefin comonomer such as 1-butene, 1-hexene or 1-octene. The most preferred comonomer is ethylene. A mixture of comonomers may also be used, e.g. forming a terpolymer. The term “copolymer” used herein is intended to cover binary copolymers as well as ternary polymers etc. Binary copolymers are preferred.

Where the polypropylene polymer is heterophasic, the polymer may comprise a semi-crystalline matrix component (A) and an amorphous component (B). Both these components may be formed from propylene and ethylene copolymers, the ethylene content in the amorphous component being higher than that of the matrix component.

For a heterophasic block copolymers, the matrix component may contain 1 to 10% of comonomer with the amorphous component containing 10 to 20 wt % comonomer. The matrix component typically forms at least 70 wt % of the block copolymer.

The polypropylene should preferably possess a high stiffness and impact strength. The tensile modulus of the polymer should therefore be at least 1000 MPa, preferably at least 1200 MPa. The presence of the organic solvent containing product in the article tends to reduce the stiffness of the article so it is important that a high stiffness material is employed in its formation. Charpy impact strengths may be at least 6 kJ/m² (23° C.) or at least 3 kJ/m² (−20° C.).

Polypropylene polymers can be made using Ziegler-Natta or single site catalysis, e.g. metallocene catalysts using well known conventional techniques. Numerous patent applications teach the use of these catalysts in the manufacture of polypropylene polymers. The production of the polypropylenes of use in the invention preferably takes place in a two stage polymerisation were a heterophasic material can be made. The use of Ziegler-Natta catalysis is preferred.

The xylene soluble fraction of the polymer may be in the range 2 to 30, especially 10 to 25 g/10 min.

Many polypropylenes are commercially available from suppliers such as Borealis, Dow, Exxon, Basell and Solvay and polypropylenes made and sold by these companies are suitable for use in this invention.

The articles of the invention should comprise at least 50 wt % polypropylene, e.g. at least 75 wt % polypropylene, e.g. at least 80 wt % polypropylene, e.g. consist essentially of polypropylene (i.e. the article contains polypropylene and standard polymer additives only). Additives such as pigments, nucleating agents, antistatic agents, fillers, UV stabilisers, antioxidants, etc., generally in amounts up to 1 wt % can be added.

In a preferred embodiment, the articles of the invention contain talc, e.g. as a nucleating agent. The amount of talc present may range from 0.01 to 10 wt %.

The articles of the invention may contain minor, e.g. up to 20% by weight, preferably up to 10% by weight of other polymer components, e.g. other polyolefins in particular polyethylenes such as low density polyethylene (LPDE), linear low density polyethylene (LLPDE), high density polyethylene (HDPE), plastomers or ethylene propylene rubber (EPR). The article may also be formed from a mixture of polypropylene components, e.g. a mixture of polypropylene components as defined above.

The wall thickness of the article formed can vary depending on the end use to which the article may be put and on its size. Larger articles have thicker walls. Conveniently however, wall thicknesses may range from 0.5 mm to 1 cm, preferably 1 mm to 5 mm.

The article of the invention also comprises at least one in mould label. The term “in mould label” is well known in the art and has a specific meaning in that the label is incorporated into the injection moulded article in the actual injection mould. Such a label is a film which possesses low levels of oxygen permeability. The in mould label is positioned on the inside surface of the article. In this application, in mould labelling involves a process in which precut labels are placed on the male side of a mould before the polymer is introduced into the mould. During the moulding process, the label and polymer melts adhere.

It is preferred if a single in mould label is employed on the inside of the article of the invention although it would be possible to use a number of labels (e.g. two labels covering different portions of the inside of the injection moulded container). It is also possible for there to be an external in mould label or labels, e.g. for conventional labelling purposes.

In this regard, in a further less preferred embodiment of the invention the in mould label is located externally only on the injection moulded article. In this embodiment the injection moulded article preferably comprises a heterophasic block copolymer of propylene and a three layer in mould label comprising two polypropylene layers sandwiching an EVOH layer, PA layer or PVAL layer.

When the in mould label is located externally the polypropylene preferably has a MFR₂ greater than 13 g/10 min, such as greater than or equal to 14 g/10 min, e.g. between 14 and 25 g/10 min, preferably at least 15 g/10 min, more preferably at least 16 g/10 min.

When the in mould label is located externally the polypropylene preferably has a density of less than 905 kg/m³, preferably less than 904 kg/m³.

Said articles having an external in mould label may be used to package non-xylene containing paints, for example, alcohol-based paints, especially alkyd paints.

The in mould label of use in this invention should possess low levels of oxygen permeability. For example at 23° C./75% Relative humidity and an 80 μm film, the oxygen transmission should be less than 100 cc/m²/day, preferably less than 20 cc/m²/day, more preferably less than 10 cc/m²/day. Thus, oxygen transmission is ideally less than 1 cc/m²/day per micron of film thickness, preferably less than 0.5 cc/m²/day per micron of film thickness.

Polymers of use in the in-mould labels of the invention include polyethylene terephthalate (PET), polyvinyl chloride (PVC), polyethylene naphthalate (PEN), polyamide (PA), polyvinyl alcohol (PVAL), ethylene vinyl alcohol (EVOH), propylene vinyl alcohol (PVOH) polyvinylidene chloride (PVDC), acrylic polymers or mixtures thereof. EVOH is a particularly preferred component of in mould labels. These polymers can be combined with other polymers such as polypropylene (PP) and polyethylene (PE) to form labels.

Blends which have been developed and shown to form effective oxygen barriers include EVOH with PP, EVOH with PE, EVOH with PA, PA with PP and PA with PET. PVDC and acrylic polymers are especially suitable as external layers within the in mould label.

Some of the in mould label polymers, e.g. PA, EVOH and PVAL, are more effective when dry and hence when employed in the in mould label may need to be combined with a water barrier layer. For example, PP is an excellent water vapour barrier and may conveniently be employed along with PA or EVOH to form a film which exhibits both oxygen and water vapour barrier properties. Where PP is employed in the in mould label, it is preferred if this is biaxially orientated.

Moreover, it is possible to metallize the in mould label polymers to improve their oxygen barrier properties. Metallisation is the deposition, in a vacuum chamber, of vaporized molecules of at least one metal (e.g. iron, or particularly aluminium or aluminium alloys) over the surface of a plastic film, thus providing a lustrous metallic appearance. Metallisation is a known process and will be readily carried out by a person skilled in the art. In a preferred embodiment however, the in mould label is not metallised.

Other potential films include thin glass-like films formed by coating polymers such as PET, PA or PP with SiOₓ. Such silica coatings can be introduced via physical vapour deposition and are commercialised by Alcan packaging, 4P Ronsberg and Mitsubishi.

Other new barrier technologies may be applicable in the invention claimed, e.g. those commercialised by Ticona (Vectran), Proctor & Gamble (Nodax), Dow (BLOX), Superex Inc. (PET or PA with liquid crystalline polymer) and nanocomposite technology. Laminated labels made from metal foil (e.g. foils of iron, aluminium or alloys) may also be used, as may labels comprising surface modified mica. Such labels provide very effective oxygen and solvent barrier properties.

Preferably however, the in mould label is formed from a multilayer polymeric structure or laminate, e.g. formed from coextrusion by conventional techniques. Such multilayer in mould labels should preferably comprise 2 to 7 layers, e.g. 3 to 5 or 5 to 7 layers. Especially preferred in mould labels are formed from PE-EVOH-PE, PP-EVOH-PP or PP-PVOH-PP optionally comprising one or more adhesive layers. In general, the in mould label should comprise a PVOH or EVOH layer.

The in mould label should preferably be 1 to 200 μm in thickness, e.g. 5 to 120 μm, especially 30 to 100 μm.

The in mould labels of use in this invention can be purchased from Companies such as Vogt, P'Auer, Pachem, Autotype etc.

In mould label technology is well known and conventional techniques may be used to implement its use in the invention, e.g. as described U.S. Pat. No. 4,837,075.

The article of the invention, which is preferably a container, may be manufactured by placing the in mould label on the male side of the injection mould, adding the plastic to the mould and carrying out the moulding process. For the injection moulding conventional moulding equipment may be used, e.g. operating at an injection temperature of 190 to 275° C. and typical pressures, e.g. 500 to 900 bar. Typically containers produced in this fashion will have a volume of 100 mL to 100 L and lids will typically have maximum dimensions of 10 to 600 mm. Container sizes are preferably greater than 100 ml, such as greater than 500 ml, preferably greater than 1 L, especially greater than 10 L.

The in mould label (or labels) should cover at least 50%, e.g. at least 70%, preferably at least 90% of the inside surface of the container, e.g. the side or sides of the container and preferably its base. In a most preferred embodiment the label should cover at least 95% e.g. the entire internal surface of the injection moulded article.

The person skilled in the art will appreciate that closures or lids are formed separately and may not comprise the in mould label. It is however, preferable if the closure means or lid also comprises an in mould label, preferably the same label as used on the container. This label may be external or internal on the closure means, preferably internal.

The injection moulded article of the invention may have one or more of the following preferred features:

Tensile modulus (E-modulus) of at least 800, preferably at least 1000, especially at least 1200 MPa (measured according to ISO 527-2);

Charpy Impact (23° C.) of at least 3 kJ/m², preferably at least 5 kJ/m², more preferably at least 7 kJ/m².

Oxygen transmission of less than 0.2 ml/package 24 h, preferably no more than 0.1 ml/package 24 h, more preferably no more than 0.06 ml/package 24 h, especially no more than 0.025 ml/package 24 h as measured by the AOIR method of Larsen et al. (2000). What is crucial here is the low oxygen transmission. It can be achieved on a container of any size or dimension and with an suitable label however it will be appreciated that the container manufacturer is looking to produce articles cheaply and therefore thin walls and labels are preferred if the necessary oxygen transmission properties can be achieved.

It will be appreciated that the oxygen transmission properties of articles vary depending on the thickness of the walls of the article and the surface area of the article. Larger articles with larger surface area for oxygen transmission have larger oxygen transmission values. If desired the value of oxygen transmission can be reported for articles with a capacity of 0.65 L made as described in the examples.

In a highly preferred embodiment, the oxygen transmission values above are obtained in articles having wall thicknesses of 1 to 5 mm and in mould labels of thickness 30 to 200 μm.

The articles of the invention have surprisingly found to swell less than articles in which the label is positioned on the outside of the article. The presence of an internal in mould label also gives rise to higher stiffness values and improved stress cracking values in comparison to an externally labelled article.

The article of the invention is used to carry products containing organic solvents. Typical organic solvents include alcohols (such as methanol, ethanol, white spirit and butanol), diols (such as ethylene glycol and propylene glycol), ketones (such as acetone or methylethylketone), aliphatic hydrocarbons (such as hexane), aromatics (such as xylene, benzene and toluene or substituted analogues thereof such as nitrobenzene and chlorobenzene), halogenated solvents (such as chloroform, dichloromethane, carbon tetrachloride and 1,1,1,-trichloroethane), sulphur containing solvents (such as DMSO), amines (such as ethylamine), amides (such dimethyl formamide), heterocyclic solvents (such as THF, pyridine, piperidine, N-methylpyrollidone), isocyanates and esters (e.g. acetates such as ethyl acetate, methyl acetate).

Most commonly, the material being package will contain alcohols such as white spirit or an aromatic compound such as xylene.

In a preferred embodiment, the material in the injection moulded article will be a solvent based material, i.e. one which the primary component is an organic solvent.

However, due to environmental concerns, the use of solvent based products is being slowly phased out, in particular in materials which are for use inside. The products which are replacing these solvent based products tend to be aqueous based, e.g. are emulsions, but they still contain significant levels of organic solvents, e.g. to dissolve non-water soluble active components. Any product which contains at least 5 wt %, preferably at least 10 wt %, more preferably at least 25%, especially at least 50% of organic solvent may be packaged according to the invention.

Products which can be packaged using the articles of the invention therefore include paints, leather tanning goods, inks, soaps, adhesives, silicones, oils (e.g. fuels), sealants, industrial and laboratory chemicals. Preferably the injected moulded article is for solvent based paint, more preferably for solvent based alkyd paint. It is preferred if the product being packaged is not a cosmetic or food product.

In this regard, paints often contain binding agents such as alkyd oils. These compounds may be cured by oxygen migration through the article wall. It has been surprisingly found that the in mould label employed in this invention also reduces or prevents curing of the binding agent containing paints. More generally, many products contain compounds which cure in the presence of oxygen, e.g. hardening agents (materials which are designed to harden on contact with air, e.g. to allow the material to dry quickly). The use of the injected moulded articles of the invention prevents oxygen entering the article and therefore prevents curing occurring. In a further preferred embodiment therefore the product packaged in the containers of the invention contains an oxygen sensitive component, e.g. a component that changes form in the presence of oxygen (e.g. cures, degrades, decomposes, reacts etc).

Thus, viewed from another aspect the invention provides an article containing paint, preferably an oxygen curing binder containing paint, formed from a polypropylene polymer and having an internal in mould label.

More generally, the invention provides an article containing a hardening agent formed from a polypropylene polymer and having an internal in mould label.

The articles made from polypropylene with internal in mould label prevent emission of the organic solvents from within the container, i.e. possess low volatile organic compound emissions (VOC's). This forms a further aspect of the invention. Thus, emissions may be less than 0.5 g solvent/day per liter of product, preferably less than 0.25 g solvent./day per liter of product (e.g. for one liter of organic solvent containing paint stored in an injection moulded article of the invention with internal in mould label, less than 0.5 g of solvent would be emitted per day) .

The invention will now be described further by reference to the following non-limiting Examples:

### General

In the Examples which follow and in the description above, the following tests are employed to measure parameters.

### MFR2

MFR₂ is determined at 230° C. using 2.16 kg load according to ISO 1133.

### Density

Density is determined using ISO 1183

### Tensile Properties

Tensile properties were measured on injection moulded samples according to ISO 527-2: 1993. Tensile modulus (E-modulus) was measured at a speed of 1 mm/min

### Charpy Impact

This method was applied on injection moulded notched samples according to ISO 179/1 eA. The samples are tested at 23° C. and at −20° C.

### Oxygen Transmission (AIOR Method)

Oxygen transmission rate values were measured by the ambient oxygen ingress rate (AOIR) method as described in the paper by Larsen et al. (2000).

Larsen, H., Kohier, A. and Magnus, E. M. 2000. Ambient Oxygen Ingress Rate method—an alternative method to Ox-Tran for measuring oxygen transmission rate of whole packages. Packag. Technol. Sci. 13(6):233-241.

### Xylene Soluble Fraction

The xylene soluble fraction (XS) as defined and described in the present invention is determined as follows: 2.0 g of polymer are dissolved in 250 mm p-xylene at 135° C. under agitation. After 30±minutes, the solution was allowed to cool for 15 minutes at ambient temperature and then allowed to settle for 30 minutes at 25±0.5° C. The solution was filtered with filter paper into two 100 mm flask. The solution from the first 100 mm vessel was evaporated in nitrogen flow and the residue dried under vacuum at 90° C. until constant weight is reached. Xylene soluble fraction (percent) can then be determined as follows:

XS%=(100×m₁×v₀)/(m₀×v₁),

wherein m₀ designates the initial polymer amount (grams), m₁ defines the weight of residue (grams), v₀ defines the initial volume (milliliter) and v₁ defines the volume of analyzed sample (milliliter).

The solution from the second 100 ml flask was treated with 200 ml of acetone under vigorous stirring. The precipitate was filtered and dried in a vacuum oven at 90° C.

This solution can be employed in order to determine the amorphous part of the polymer (AM) using the following equation:

AM%=(100×m₁×v₀)/(m₀×v₁)

wherein m₀ designates the initial polymer amount (grams), m₁ defines the weight of residue (grams), v₀ defines the initial volume (milliliter) and v₁ defines the volume of analyzed sample (milliliter).

### Intrinsic Viscosity

Intrinsic viscosity is measured in accordance with ISO 1628.

### Comonomer Content

Comonomer content (weight percent) is determined in a known manner based on FTIR, calibrated with C13NMR

### EXAMPLE 1

The following heterophasic block polypropylene copolymer was employed:

TABLE 1

| | Polymer properties* |
|---|---|
| MFR₂ | 13 g/10 min |
| Density | 905 kg/m3 |
| Tensile modulus [mPa] | 1400 |
| Charpy impact [kJ/m²] 23° C./−20° C. | 8.0/4.0 |
| Tensile Strain at yield | 6% |
| Tensile Stress at yield | 26 MPa |

*(where appropriate measured on injected moulded specimens according to ISO 1873-2(97))

### EXAMPLE 2

### In Mould Label

The following in mould label was employed.

80 μm PP-EVOH-PP barrier film (Trade name G.S.V.6) obtainable from Vogt with the properties in Table 2:

TABLE 2

| | Test Method | Unit | Value | |
|---|---|---|---|---|
| Haze | ASTM D1003 | | 6 | |
| Gloss | ASTM D2457 | | 80 | |
| COF | ASTM D1894 | | 0.15-0.30 | |
| Impact Strength | ASTM D1709 | | 80.5 | |
| | | | MD | TD |
| Tensile at yield | ASTM D882 | N/mm² | 21 | 21 |
| Tensile at break | ASTM D882 | N/mm² | 30 | 24 |
| Elong at break | ASTM D882 | (%) | 680 | 642 |
| Tear str | ASTM D1938 | | 11.0 | 10.2 |

| | | | |
|---|---|---|---|
| O₂ Transmission | ASTM D3985 | cc/m²/day | 5 |
| | 23° C./75% RH | | |
| WVTR | ASTM F1249 | g · m²/day | 4 |
| | 38° C./90% RH | | |

(MD = machine direction, TD transverse direction, WVTR is water vapour transmission, COF is coefficient of friction)

### EXAMPLE 3

### Injection Moulded Container

The polypropylene was injection moulded using the following procedure to give a container.

Injection moulding took place in a 120 t Nestal Syngergy injection moulding machine employing the conditions below. The formed container was rectangular with a capacity of 0.65 L and wall thickness of 1.2 mm. The lid was produced in the same machine using a separate mould. Containers and lids were made using the polymer set out in Table 1.

Container Injection Moulding Conditions:

Temperature: 250° C.

Holding Pressure: 500 bar

Holding Time: 3 secs

Cooling time: 5 secs

### Lid Injection Moulding Conditions:

Temperature: 250° C.

Holding Pressure: 500 bar

Holding Time: 2 secs

Cooling time: 4 secs

An In Mould label was placed manually on the male (internal label) or female (external label) side of the mould for the lid/container prior to plastic injection. The label employed for both container and lid was the butterfly label available from Vogt with barrier properties of O₂TR 5 cc/m2/day described above. A control container without in mould label was also formed under identical conditions.

The label covered 95% of the inner/outer surface of the packaging exposed to the container content.

### EXAMPLE 4

### Solvent Loss

Containers were filled with 0.65 L of Penguard Primer (which contains the following volatile compounds: 10-25 wt % xylene, 2.5 to 10 wt % butan-1-ol, 2.5 to 10 wt % naphtha, 2.5 to 10 wt % ethylbenzene, 2.5 to 10 wt % 1-methoxy-2-propanol) and sealed using a lid. The weight of the container before and then after 21 days at 40° C. was taken. The containers were then held at 23° C. for 28 days and the weight again taken. Results are presented in Table 3

TABLE 3

| | No | Label | Label |
|---|---|---|---|
| Label | label | outside | inside |
| Storage 40° C.: Initial weight (g) | 617.3 | 608.3 | 636.5 |
| After 21 days at 40° C. (g) | 567.3 | 588.1 | 632.9 |
| Difference (g) | 50.0 | 20.2 | 3.6 |
| After 21 days at 40° C. followed by 28 days | 552.5 | 581.9 | 629.4 |
| at 23° C. | | | |
| Difference (over 28 days at 23° C.) (g) | 14.8 | 6.2 | 3.5 |
| Total wt loss over 49 days (g) | 64.8 | 26.4 | 7.1 |
| Total wt loss over 49 days % (g) | 10.5 | 4.3 | 1.1 |

Thus, VOC losses over 49 days were 90% less than a container with no label and 75% better than a container with external label.

### EXAMPLE 4

### Oxygen Transmission

Oxygen transmission rate values were measured by the ambient oxygen ingress rate (AOIR) method as described in the paper by Larsen et al. (2000). AOIR is a method to measure oxygen transmission rate for the whole packaging. The packages were mounted to a combined flushing and sampling port prior to flushing with nitrogen. The first (initial) O₂-concentration in the packages was measured after 1 day of storage at 23° C. and 50% RH. The second (final) O₂-concentration in the packages was measured after 4 days of storage at the same storage conditions. The O₂-concentration was measured by the use of a specially designed syringe for gas sampling, and the gas sample was injected into a Mocon/Toray oxygen analyser LC-700F (Modem Controls Inc, Minnesota, USA) with a zirconium oxide cell. Additionally, the volume of the packages was registered. The oxygen transmission rate of the packages, given as m1 O₂/package/day, was finally calculated according to the equations given by Larsen et al. (2000).

The containers of Example 3 with no label and with internal in mould label were used. The AOIR for the two sets of containers was measured under the conditions below and the results are shown in the table below.

Conditions: 23° C. Outside the container 50% relative humidity, inside nitrogen.

| | | Internal in |
|---|---|---|
| Label | No label | mould label |
| Oxygen Transmission rate [ml/pkg 24 hr] | 0.52 ± 0.00 | 0.06 ± 0.00 |

A reduction of oxygen transmission of 90% was observed by the inclusion of an in mould label.

Larsen, H., Kohier, A. and Magnus, E. M. 2000. Ambient Oxygen Ingress Rate method—an alternative method to Ox-Tran for measuring oxygen transmission rate of whole packages. Packag. Technol. Sci. 13(6):233-241.

1. An injection molded article comprising a polypropylene polymer and having an in mold label located inside said article, said article containing a product comprising an organic solvent.

2. An injection molded article comprising a polypropylene polymer having an in mold label located inside said article, said polymer having an MFR₂ of greater than 10 g/10 min.

3. The injection molded article as claimed in claim 1 wherein said solvent is xylene or white spirit.

4. The article as claimed in claim 1 wherein the polypropylene has an MFR₂ of greater than 10 g/10 min.

5. The article as claimed in claim 1, wherein the polypropylene is a copolymer.

6. The article as claimed in claim 1, wherein the polypropylene is a heterophasic block copolymer.

7. The article as claimed in claim 1 which comprises at least 70 wt % of the polypropylene.

8. The article as claimed in claim 1, having an oxygen transmission of less than 0.2 ml/package 24 h.

9. The article as claimed in claim 1, wherein said in mold label has an oxygen transmission of less than 100 cc/m²/day at 23° C. and 75% relative humidity.

10. The article as claimed in claim 1, wherein said in mold label comprises at least one polymeric material selected from the group consisting of polyethylene terephthalate, polyvinyl chloride, polyethylene naphthalate, polyamide, polyvinyl alcohol, ethylene vinyl alcohol, propylene vinyl alcohol, polyvinylidene chloride and acrylic polymers.

11. The article as claimed in claim 1, wherein said in mold label is a multi-layered laminate.

12. The article as claimed in claim 1, wherein said in mold label is non-metalized.

13. The article as claimed in claim 1, wherein the in mold label comprises EVOH.

14. The article as claimed in claim 1 comprising at least one in mold label covering a total of at least 50% of the surface of said article.

15. The article as claimed in claim 1 wherein said solvent is an alcohol, ketone, aliphatic hydrocarbon, aromatic, halogenated solvent, sulfur containing solvent, amine, amide, heterocyclic solvent, isocyanate or ester.

16. The article being a container as claimed in claim 1 containing a solvent based product selected from the group of paints, leather tanning goods, inks, soaps, adhesives, oils, silicones, sealants, industrial and laboratory chemicals.

17. The article of claim 1, wherein the product is paint.

18. (canceled)

19. The article of claim 17 wherein said paint contains an alkyd oil.

20. A process for the preparation of an injection molded article, said process comprising:
(I) placing an in mold label on the male side of an injection mold;
(II) injecting a polypropylene polymer into said injection mold to form said article, said polymer;
(III) removing said article from the mould.

21. The process as claimed in claim 20 further comprising:
(IV) adding a product containing an organic solvent to said article.

22. (canceled)

23. An injection molded article comprising a polypropylene polymer and having an in mold label located only outside said article, said article containing a non-xylene containing paint.

24. The injection molded article as claimed in claim 23 wherein said paint is an alkyd paint.

25. The process of claim 20, wherein said polymer has an MFR₂ of greater than 10 g/10 min.
